(19) United States
(12) Patent Application Publication
(10) Pub. No.: US 2023/0308229 A1
(43) Pub. Date: Sep. 28, 2023

(54) APPARATUS, METHOD, AND COMPUTER PROGRAM

(71) Applicant: NOKIA TECHNOLOGIES OY, Espoo (FI)

(72) Inventor: Ping-Heng KUO, London (GB)

(21) Appl. No.: 18/006,018

(22) PCT Filed: Jul. 20, 2020
(86) PCT No.: PCT/EP2020/070452

§ 371 Date: Jan. 19, 2023

(51) Int. Cl. H04L 1/22; H04L 1/08

(52) U.S. Cl. CPC H04L 1/22; H04L 1/08

(57) ABSTRACT

An apparatus comprising: at least one processor; and at least one memory including computer program code; the at least one memory and the computer program code configured to, with the at least one processor, cause the apparatus at least to: determine that a packet data unit from a higher protocol layer entity is associated with a risk of survival time violation; and select between one or more first lower data protocol entities and one or more second lower protocol layer entities to process the protocol packet data unit.

### FIELD OF THE DISCLOSURE

The present disclosure relates to an apparatus, a method, and a computer program for selecting between one or more first lower protocol layer entities and one or more second lower protocol layer entities to process a packet data unit from a higher protocol layer entity associated with a risk of survival time violation in a communication system.

### BACKGROUND

A communication system can be seen as a facility that enables communication sessions between two or more entities such as user terminals, base stations/access points and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet. In a wireless communication system at least a part of a communication session between at least two stations occurs over a wireless link.

A user can access the communication system by means of an appropriate communication device or terminal. A communication device of a user is often referred to as user equipment (UE) or user device. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known as the long-term evolution (LTE) or the Universal Mobile Telecommunications System (UMTS) radio-access technology. Another example communication system is so called 5G radio or new radio (NR) access technology.

### SUMMARY

According to an aspect there is provided an apparatus comprising at least one processor and at least one memory including computer code for one or more programs, the at least one memory and the computer code configured, with the at least one processor, to cause the apparatus at least to: determine that a packet data unit from a higher protocol layer entity is associated with a risk of survival time violation; and select between one or more first lower data protocol entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The at least one memory and the computer program code may be configured to, with the at least one processor, cause the apparatus at least to: select between the one or more first lower protocol layer entities and the one or more second lower protocol layer entities to process the packet data unit from the higher protocol layer entity based on: an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The operating mode of the one or more first lower protocol layer entities and the operating mode of the one or more second lower protocol layer entities may be one of an acknowledgement mode, an unacknowledgement mode and a transparent mode.

The number of active lower protocol layer entities of the one or more first lower protocol layer entities may be greater than the number of active lower protocol layer entities of the one or more second lower protocol layer entities; the congestion within the one or more first lower protocol layer entities may be lower than the one or more second lower protocol layer entities; or the radio link condition of a cell group serving the one or more first lower protocol layer entities may be greater than the one or more second lower protocol layer entities.

The at least one memory and the computer program code may be configured to, with the at least one processor, cause the apparatus at least to: select the one or more first lower protocol layer entities to process the packet data unit from the higher protocol layer entity.

The number of active lower protocol layer entities of the one or more first lower protocol layer entities may be lower than the number of active lower protocol layer entities of the one or more second lower protocol layer entities; the congestion within the one or more first lower protocol layer entities may be greater than the one or more second lower protocol layer entities; or the radio link condition of a cell group serving the one or more first lower protocol layer entities may be lower than the one or more second lower protocol layer entities.

The at least one memory and the computer program code may be configured to, with the at least one processor, cause the apparatus at least to: select the one or more second lower protocol layer entities to process the packet data unit from the higher protocol layer entity.

The at least one memory and the computer program code may be configured to, with the at least one processor, cause the apparatus at least to: determine that a packet data unit from the higher protocol layer entity is not associated with a risk of survival time violation; and select the one or more second lower protocol layer entities to process the packet data unit from the higher protocol layer entity.

Determining whether a packet data unit from the higher protocol layer entity may be associated with a risk of survival time violation is based on a sequence number of the packet data unit.

Determining whether a packet data unit from the higher protocol layer entity may be associated with a risk of survival time violation is based on whether a previous packet data unit was successfully transmitted.

The second lower protocol layer entities may be default lower protocol layer entities and the first lower protocol layer entities are alternative lower protocol layer entities.

The at least one memory and the computer program code may be configured to, with the at least one processor, cause the apparatus at least to: submit the packet data unit from the higher protocol layer entity to the selected one or more first lower protocol layer entity or the one or more second lower protocol layer entity entities.

The at least one memory and the computer program code may be configured to, with the at least one processor, cause the apparatus at least to: determine that the packet data unit from the higher protocol layer entity is associated with a risk of survival time violation for a specific data radio bearer.

The at least one memory and the computer program code may be configured to, with the at least one processor, cause the apparatus at least to: receive a configuration message from a base station to: determine that a packet data unit from the higher protocol layer entity is associated with a risk of survival time violation; and select between one or more first lower protocol layer entities and one or more second lower protocol layer entities to process the packet data unit based on least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The higher protocol layer entity may be a packet data convergence protocol entity; the one or more first lower protocol layer entities may be one or more first radio link control entities; and the one or more second lower protocol layer entities may be one or more second radio link control entities.

The apparatus may be a terminal.

According to an aspect there is provided an apparatus comprising means for: determining that a packet data unit from a higher protocol layer entity is associated with a risk of survival time violation; and selecting between one or more first lower data protocol entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The apparatus may comprise means for: selecting between the one or more first lower protocol layer entities and the one or more second lower protocol layer entities to process the packet data unit from the higher protocol layer entity based on: an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The operating mode of the one or more first lower protocol layer entities and the operating mode of the one or more second lower protocol layer entities may be one of an acknowledgement mode, an unacknowledgement mode and a transparent mode.

The number of active lower protocol layer entities of the one or more first lower protocol layer entities may be greater than the number of active lower protocol layer entities of the one or more second lower protocol layer entities; the congestion within the one or more first lower protocol layer entities may be lower than the one or more second lower protocol layer entities; or the radio link condition of a cell group serving the one or more first lower protocol layer entities may be greater than the one or more second lower protocol layer entities.

The apparatus may comprise means for: selecting the one or more first lower protocol layer entities to process the packet data unit from the higher protocol layer entity.

The number of active lower protocol layer entities of the one or more first lower protocol layer entities may be lower than the number of active lower protocol layer entities of the one or more second lower protocol layer entities; the congestion within the one or more first lower protocol layer entities may be greater than the one or more second lower protocol layer entities; or the radio link condition of a cell group serving the one or more first lower protocol layer entities may be lower than the one or more second lower protocol layer entities.

The apparatus may comprise means for: selecting the one or more second lower protocol layer entities to process the packet data unit from the higher protocol layer entity.

The apparatus may comprise means for: determining that a packet data unit from the higher protocol layer entity is not associated with a risk of survival time violation; and select the one or more second lower protocol layer entities to process the packet data unit from the higher protocol layer entity.

Determining whether a packet data unit from the higher protocol layer entity may be associated with a risk of survival time violation is based on a sequence number of the packet data unit.

Determining whether a packet data unit from the higher protocol layer entity may be associated with a risk of survival time violation is based on whether a previous packet data unit was successfully transmitted.

The second lower protocol layer entities may be default lower protocol layer entities and the first lower protocol layer entities are alternative lower protocol layer entities.

The apparatus may comprise means for: submitting the packet data unit from the higher protocol layer entity to the selected one or more first lower protocol layer entity or the one or more second lower protocol layer entity entities.

The apparatus may comprise means for: determining that the packet data unit from the higher protocol layer entity is associated with a risk of survival time violation for a specific data radio bearer.

The apparatus may comprise means for: receiving a configuration message from a base station to: determine that a packet data unit from the higher protocol layer entity is associated with a risk of survival time violation; and select between one or more first lower protocol layer entities and one or more second lower protocol layer entities to process the packet data unit based on least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The higher protocol layer entity may be a packet data convergence protocol entity; the one or more first lower protocol layer entities may be one or more first radio link control entities; and the one or more second lower protocol layer entities may be one or more second radio link control entities.

The apparatus may be a terminal.

According to an aspect there is provided an apparatus comprising circuitry configured to: determine that a packet data unit from a higher protocol layer entity is associated with a risk of survival time violation; and select between one or more first lower data protocol entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The apparatus may comprise circuitry configured to: select between the one or more first lower protocol layer entities and the one or more second lower protocol layer entities to process the packet data unit from the higher protocol layer entity based on: an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The operating mode of the one or more first lower protocol layer entities and the operating mode of the one or more second lower protocol layer entities may be one of an acknowledgement mode, an unacknowledgement mode and a transparent mode.

The number of active lower protocol layer entities of the one or more first lower protocol layer entities may be greater than the number of active lower protocol layer entities of the one or more second lower protocol layer entities; the congestion within the one or more first lower protocol layer entities may be lower than the one or more second lower protocol layer entities; or the radio link condition of a cell group serving the one or more first lower protocol layer entities may be greater than the one or more second lower protocol layer entities.

The apparatus may comprise circuitry configured to: select the one or more first lower protocol layer entities to process the packet data unit from the higher protocol layer entity.

The number of active lower protocol layer entities of the one or more first lower protocol layer entities may be lower than the number of active lower protocol layer entities of the one or more second lower protocol layer entities; the congestion within the one or more first lower protocol layer entities may be greater than the one or more second lower protocol layer entities; or the radio link condition of a cell group serving the one or more first lower protocol layer entities may be lower than the one or more second lower protocol layer entities.

The apparatus may comprise circuitry configured to: select the one or more second lower protocol layer entities to process the packet data unit from the higher protocol layer entity.

The apparatus may comprise circuitry configured to: determine that a packet data unit from the higher protocol layer entity is not associated with a risk of survival time violation; and select the one or more second lower protocol layer entities to process the packet data unit from the higher protocol layer entity.

Determining whether a packet data unit from the higher protocol layer entity may be associated with a risk of survival time violation is based on a sequence number of the packet data unit.

Determining whether a packet data unit from the higher protocol layer entity may be associated with a risk of survival time violation is based on whether a previous packet data unit was successfully transmitted.

The second lower protocol layer entities may be default lower protocol layer entities and the first lower protocol layer entities are alternative lower protocol layer entities.

The apparatus may comprise circuitry configured to: submit the packet data unit from the higher protocol layer entity to the selected one or more first lower protocol layer entity or the one or more second lower protocol layer entity entities.

The apparatus may comprise circuitry configured to: determine that the packet data unit from the higher protocol layer entity is associated with a risk of survival time violation for a specific data radio bearer.

The apparatus may comprise circuitry configured to: receive a configuration message from a base station to: determine that a packet data unit from the higher protocol layer entity is associated with a risk of survival time violation; and select between one or more first lower protocol layer entities and one or more second lower protocol layer entities to process the packet data unit based on least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The higher protocol layer entity may be a packet data convergence protocol entity; the one or more first lower protocol layer entities may be one or more first radio link control entities; and the one or more second lower protocol layer entities may be one or more second radio link control entities.

The apparatus may be a terminal.

According to an aspect there is provided a method comprising: determining that a packet data unit from a higher protocol layer entity is associated with a risk of survival time violation; and selecting between one or more first lower data protocol entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The method may comprise: selecting between the one or more first lower protocol layer entities and the one or more second lower protocol layer entities to process the packet data unit from the higher protocol layer entity based on:
an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The operating mode of the one or more first lower protocol layer entities and the operating mode of the one or more second lower protocol layer entities may be one of an acknowledgement mode, an unacknowledgement mode and a transparent mode.

The number of active lower protocol layer entities of the one or more first lower protocol layer entities may be greater than the number of active lower protocol layer entities of the one or more second lower protocol layer entities; the congestion within the one or more first lower protocol layer entities may be lower than the one or more second lower protocol layer entities; or the radio link condition of a cell group serving the one or more first lower protocol layer entities may be greater than the one or more second lower protocol layer entities.

The method may comprise: selecting the one or more first lower protocol layer entities to process the packet data unit from the higher protocol layer entity.

The number of active lower protocol layer entities of the one or more first lower protocol layer entities may be lower than the number of active lower protocol layer entities of the one or more second lower protocol layer entities; the congestion within the one or more first lower protocol layer entities may be greater than the one or more second lower protocol layer entities; or the radio link condition of a cell group serving the one or more first lower protocol layer entities may be lower than the one or more second lower protocol layer entities.

The method may comprise: selecting the one or more second lower protocol layer entities to process the packet data unit from the higher protocol layer entity.

The method may comprise: determining that a packet data unit from the higher protocol layer entity is not associated with a risk of survival time violation; and select the one or more second lower protocol layer entities to process the packet data unit from the higher protocol layer entity.

Determining whether a packet data unit from the higher protocol layer entity may be associated with a risk of survival time violation is based on a sequence number of the packet data unit.

Determining whether a packet data unit from the higher protocol layer entity may be associated with a risk of survival time violation is based on whether a previous packet data unit was successfully transmitted.

The second lower protocol layer entities may be default lower protocol layer entities and the first lower protocol layer entities are alternative lower protocol layer entities.

The method may comprise: submitting the packet data unit from the higher protocol layer entity to the selected one or more first lower protocol layer entity or the one or more second lower protocol layer entity entities.

The method may comprise: determining that the packet data unit from the higher protocol layer entity is associated with a risk of survival time violation for a specific data radio bearer.

The method may comprise: receiving a configuration message from a base station to: determine that a packet data unit from the higher protocol layer entity is associated with a risk of survival time violation; and select between one or more first lower protocol layer entities and one or more second lower protocol layer entities to process the packet data unit based on least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The higher protocol layer entity may be a packet data convergence protocol entity; the one or more first lower protocol layer entities may be one or more first radio link control entities; and the one or more second lower protocol layer entities may be one or more second radio link control entities.

The method may be performed by a terminal.

According to an aspect there is provided a computer program comprising computer executable code which when run on at least one processor is configured to: determine that a packet data unit from a higher protocol layer entity is associated with a risk of survival time violation; and select between one or more first lower data protocol entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The computer program may comprise computer executable code which when run on at least one processor is configured to: select between the one or more first lower protocol layer entities and the one or more second lower protocol layer entities to process the packet data unit from the higher protocol layer entity based on: an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The operating mode of the one or more first lower protocol layer entities and the operating mode of the one or more second lower protocol layer entities may be one of an acknowledgement mode, an unacknowledgement mode and a transparent mode.

The number of active lower protocol layer entities of the one or more first lower protocol layer entities may be greater than the number of active lower protocol layer entities of the one or more second lower protocol layer entities; the congestion within the one or more first lower protocol layer entities may be lower than the one or more second lower protocol layer entities; or the radio link condition of a cell group serving the one or more first lower protocol layer entities may be greater than the one or more second lower protocol layer entities.

The computer program may comprise computer executable code which when run on at least one processor is configured to: select the one or more first lower protocol layer entities to process the packet data unit from the higher protocol layer entity.

The number of active lower protocol layer entities of the one or more first lower protocol layer entities may be lower than the number of active lower protocol layer entities of the one or more second lower protocol layer entities; the congestion within the one or more first lower protocol layer entities may be greater than the one or more second lower protocol layer entities; or the radio link condition of a cell group serving the one or more first lower protocol layer entities may be lower than the one or more second lower protocol layer entities.

The computer program may comprise computer executable code which when run on at least one processor is configured to: select the one or more second lower protocol layer entities to process the packet data unit from the higher protocol layer entity.

The computer program may comprise computer executable code which when run on at least one processor is configured to: determine that a packet data unit from the higher protocol layer entity is not associated with a risk of survival time violation; and select the one or more second lower protocol layer entities to process the packet data unit from the higher protocol layer entity.

Determining whether a packet data unit from the higher protocol layer entity may be associated with a risk of survival time violation is based on a sequence number of the packet data unit.

Determining whether a packet data unit from the higher protocol layer entity may be associated with a risk of survival time violation is based on whether a previous packet data unit was successfully transmitted.

The second lower protocol layer entities may be default lower protocol layer entities and the first lower protocol layer entities are alternative lower protocol layer entities.

The computer program may comprise computer executable code which when run on at least one processor is configured to: submit the packet data unit from the higher protocol layer entity to the selected one or more first lower protocol layer entity or the one or more second lower protocol layer entity entities.

The computer program may comprise computer executable code which when run on at least one processor is configured to: determine that the packet data unit from the higher protocol layer entity is associated with a risk of survival time violation for a specific data radio bearer.

The computer program may comprise computer executable code which when run on at least one processor is configured to: receive a configuration message from a base station to: determine that a packet data unit from the higher protocol layer entity is associated with a risk of survival time violation; and select between one or more first lower protocol layer entities and one or more second lower protocol layer entities to process the packet data unit based on least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The higher protocol layer entity may be a packet data convergence protocol entity; the one or more first lower protocol layer entities may be one or more first radio link control entities; and the one or more second lower protocol layer entities may be one or more second radio link control entities.

The at least one processor may be part of a terminal.

According to an aspect there is provided an apparatus comprising at least one processor and at least one memory including computer code for one or more programs, the at least one memory and the computer code configured, with the at least one processor, to cause the apparatus at least to: send a configuration message to a terminal to: determine that a packet data unit from a higher protocol layer entity is associated with a risk of survival time violation; and select between one or more first lower protocol layer entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The apparatus may be a base station.

According to an aspect there is provided an apparatus comprising means for: sending a configuration message to a terminal to: determine that a packet data unit from a higher protocol layer entity is associated with a risk of survival time violation; and select between one or more first lower protocol layer entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The apparatus may be a base station.

According to an aspect there is provided an apparatus comprising circuitry configured to: send a configuration message to a terminal to: determine that a packet data unit from a higher protocol layer entity is associated with a risk of survival time violation; and select between one or more first lower protocol layer entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The apparatus may be a base station.

According to an aspect there is provided a method comprising: sending a configuration message to a terminal to: determine that a packet data unit from a higher protocol layer entity is associated with a risk of survival time violation; and select between one or more first lower protocol layer entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The method may be performed by a base station.

According to an aspect there is provided a computer program comprising computer executable code which when run on at least one processor is configured to: send a configuration message to a terminal to: determine that a packet data unit from a higher protocol layer entity is associated with a risk of survival time violation; and select between one or more first lower protocol layer entities and one or more second lower protocol layer entities to process the packet data unit based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The at least one processor may be part of a base station.

According to an aspect, there is provided a computer readable medium comprising program instructions stored thereon for performing at least one of the above methods.

According to an aspect, there is provided a non-transitory computer readable medium comprising program instructions stored thereon for performing at least one of the above methods.

According to an aspect, there is provided a non-volatile tangible memory medium comprising program instructions stored thereon for performing at least one of the above methods.

In the above, many different aspects have been described. It should be appreciated that further aspects may be provided by the combination of any two or more of the aspects described above.

Various other aspects are also described in the following detailed description and in the attached claims.

### LIST OF ABBREVIATIONS

AF: Application Function
AM: Acknowledgement Mode
AMF: Access Management Function
ARQ: Automatic ReQuest
AUSF: Authentication Server Function
BS: Base Station
BSF: Binding Support Function
CU: Centralized Unit
DL: Downlink
DN: Data Network
DRB: Data Radio Bearer
DU: Distributed Unit
E2E: End to End
eNB: eNodeB
gNB: gNodeB
GSM: Global System for Mobile communication
HSS: Home Subscriber Server
IMS: IP multimedia subsystem
IoT: Internet of Things
IIoT: Industrial IoT
IP: Internet Protocol
LCH: Logical CHannel
LTE: Long Term Evolution
MAC: Medium Access Control
MS: Mobile Station
MTC: Machine Type Communication
NEF: Network Exposure Function
NF: Network Function
NR: New radio
NRF: Network function Repository Function
PCC: Policy and Charging Control
PCF: Policy Control Function
PDCP: Packet Data Convergence Protocol
PDU: Packet Data Unit
PSA: PDU session anchor
RAM: Random Access Memory
(R)AN: (Radio) Access Network
RLC: Radio Link Control
ROM: Read Only Memory
SMF: Session Management Function
TR: Technical Report
TS: Technical Specification
TSC: Time Sensitive Communication
UE: User Equipment
UL: Uplink
UM: Unacknowledged Mode
UP: User Plane
UMTS: Universal Mobile Telecommunication System
URLLC: Ultra-Reliable Low Latency Communication
USB: Universal Serial Bus
3GPP: 3^{rd} Generation Partnership Project
5G: 5^{th} Generation
5GC: 5G Core network
5GS: 5G System

### BRIEF DESCRIPTION OF THE FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a survival time requirement for time sensitive communication expressed in terms of a number of consecutive packet delivery failure;

FIG. 5 shows a schematic representation of a mechanism for selecting between one or more first radio link control entities and one or more second radio link control entities to process a packet data unit from a packet data convergence protocol entity;

FIG. 6 shows a schematic representation of a flow chart of a method for selecting between one or more first radio link control entities and one or more second radio link control entities to process a packet data unit from a packet data convergence protocol entity;

FIG. 7 shows a schematic representation of a block diagram of a method performed by a terminal for selecting between one or more first radio link control entities and one or more second radio link control entities to process a packet data unit from a packet data convergence protocol entity associated with a risk of survival time violation;

FIG. 8 shows a schematic representation of a block diagram of a method performed by a base station for selecting between one or more first radio link control entities and one or more second radio link control entities to process a packet data unit from a packet data convergence protocol entity associated with a risk of survival time violation; and

FIG. 9 shows a schematic representation of a non-volatile memory medium storing instructions which when executed by a processor allow a processor to perform one or more of the steps of the method of FIGS. 7 and 8.

### DETAILED DESCRIPTION OF THE FIGURES

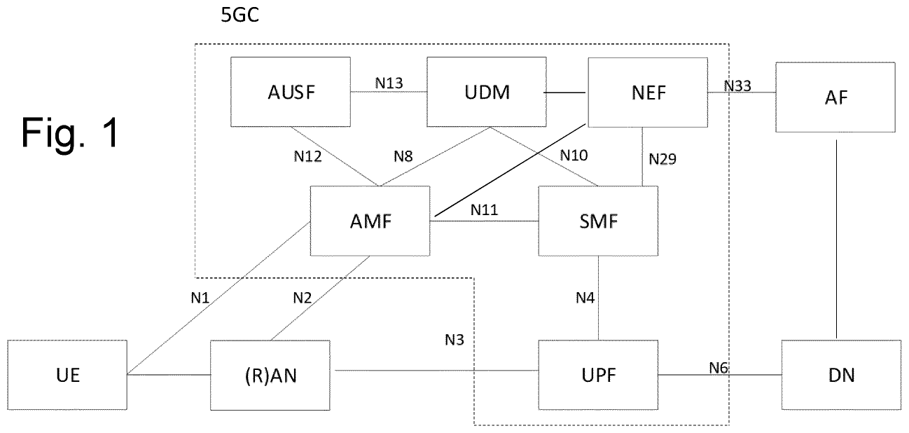

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may comprises a terminal, a (radio) access network ((R)AN), a 5G core network (5GC), one or more application functions (AF) and one or more data networks (DN).

The 5G (R)AN may comprise one or more gNodeB (gNB) distributed unit functions connected to one or more gNodeB (gNB) centralized unit functions.

The 5GC may comprise an access management function (AMF), a session management function (SMF), an authentication server function (AUSF), a user data management (UDM), a user plane function (UPF) and/or a network exposure function (NEF). Although not illustrated the 5GC may comprise other network functions (NF), such as a network address and/or port translation function (NAPTF), a network function repository function (NRF) or a binding support function (BSF).

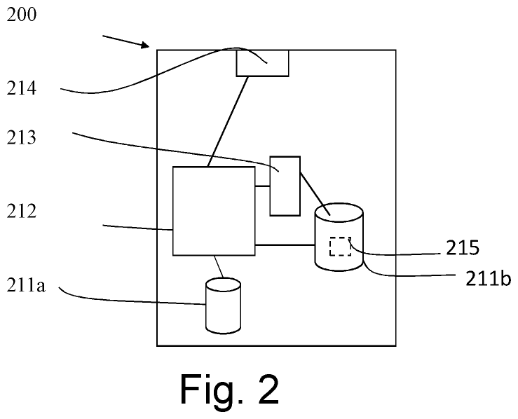

FIG. 2 illustrates an example of a control apparatus 200 for controlling a function of the (R)AN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G (R)AN or the 5GC. In some embodiments, each function of the (R)AN or the 5GC comprises a control apparatus 200. In alternative embodiments, two or more functions of the (R)AN or the 5GC may share a control apparatus.

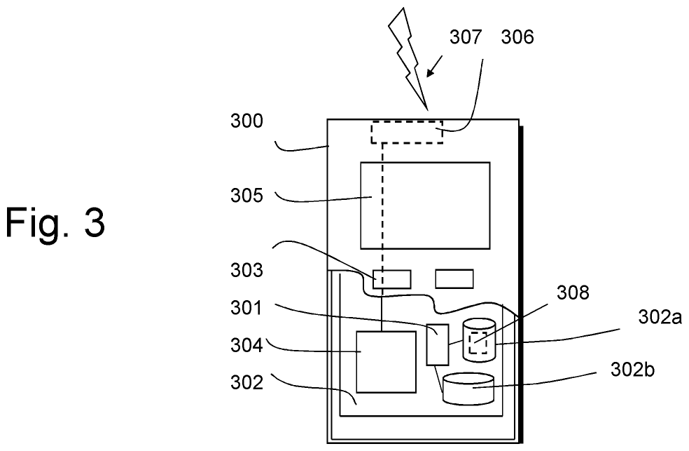

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302a and the ROM 211b. The at least one processor 301 may be configured to execute an appropriate software code 308. The software code 308 may for example allow to perform one or more of the present aspects. The software code 308 may be stored in the ROM 302b.

The processor, storage and other relevant control apparatus can be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

It has been identified that time sensitive communication (TSC) traffic for industrial IoT (IIoT) use cases may have special requirements compared to conventional data traffic. More specifically, to ensure seamless operation of IIoT use cases, a communication service may need to fulfil a so-called “survival time”. The definition of survival time has been given in TS 22.104:
“Survival time: the time that an application consuming a communication service may continue without an anticipated message”.

The survival time may indicate to the communication service the time available to recover from failure. The survival time can be expressed as a time period or, especially with periodic traffic, as a maximum number of consecutive messages incorrectly received or lost.

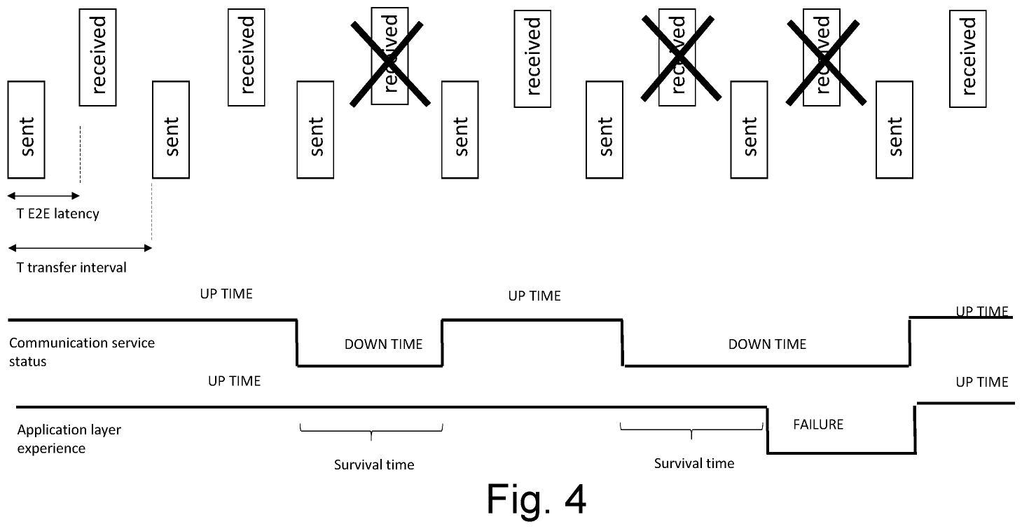

An example is shown in FIG. 4 where survival time is expressed in terms of a maximum number of consecutive messages incorrectly received or lost. The survival time is violated and an application failure occurs when N consecutive packets (e.g. N=2) are not incorrectly received or lost.

In 5G NR framework, a packet data convergence protocol (PDCP) entity may be configured for a data radio bearer (DRB and multiple radio link control (RLC) entities may be associated to the PDCP entity for purposes of duplication and/or split bearer. Currently all RLC entities associated with a PDCP entity operate in a same operating mode (i.e. acknowledgement mode (AM) or unacknowledgement mode (UM)).

The AM may provide better reliability than the UM because automatic request (ARQ) retransmission may be applied in cases of erroneous transmission. However, the AM may be slower and may consume more computing and storage resources than the UM. Thus, the UM may typically be used for handling of ultra-reliable low latency communication (URLLC) traffic.

Nevertheless, for traffic with survival time requirement where different reliability targets might be needed for different bursts to prevent consecutive error, it may be questionable whether applying the UM to all bursts from a same traffic stream is sensible in terms of survival time fulfilment.

In light of this it may be desirable to provide a mechanism providing a trade-off between processing complexity and survival time fulfilment.

It has been proposed that different logical channel (LCH) mapping restrictions may be configured at a medium access control (MAC) for different LCH associated to a same DRB. The LCH mapping restrictions may maintains the reliability level by limiting the physical radio resource that each packet can be mapped to. A terminal may process different packets from a same DRB by processing them in different LCHs to reduce probability of consecutive error. However, this proposal does not consider the operation mode of RLC entities.

R2-1818339 has proposed that RLC entities associated with a DRB for duplication could be configured in different operating modes. Multiple copies of a PDCP PDU may be submitted to an RLC entity operating in the AM and to an RLC entity operating in the UM in a hope to get benefits of both reliability and latency. This means that the RLC entity operating in the AM may still need to process all packets in the data stream which costs more computing and storage resources. Besides, this scheme may not bring clear benefits of consecutive packet error avoidance for survival time protection, because all back-to-back packets are processed in a similar fashion.

One or more aspects of this disclosure provide an uplink mechanism where multiple RLC entities associated with a PDCP entity may be divided into two subsets of RLC entities operating in different operating modes. For example, a subset of first RLC entities may operate in an AM and a subset of second RLC entities may operate in an UM. The subset of first RLC entities may comprise one or more RLC entities. The subset of second RLC entities may comprise one or more RLC entities. The PDCP entity may select between the subset of first RLC entities and the subset of second RLC entities to process a PDCP PDU depending on whether there is a risk of survival time violation associated with the PDCP PDU. The different subsets of RLC entities may correspond to different cell groups or MAC entities.

The PDCP entity may select the subset of first RLC entities to process every N-th PDCP PDU (i.e. one PDCP PDU out of N). In the example of FIG. 4, the PDCP entity may select the subset of first RLC entities (operating in AM) to process every second PDCP PDU (i.e. one PDCP PDU out of two). In this way, the PDCP entity may ensure that every N-th PDCP PDCP PDU is processed with higher reliability due to AM and may reduce the probability of N consecutive PDCP PDUs being incorrectly received or lost. Moreover, it may save computing and/or storage resource by submitting all other PDCP PDUs to the subset of second RLC entities (operating in UM) instead of the subset of first RLC entities.

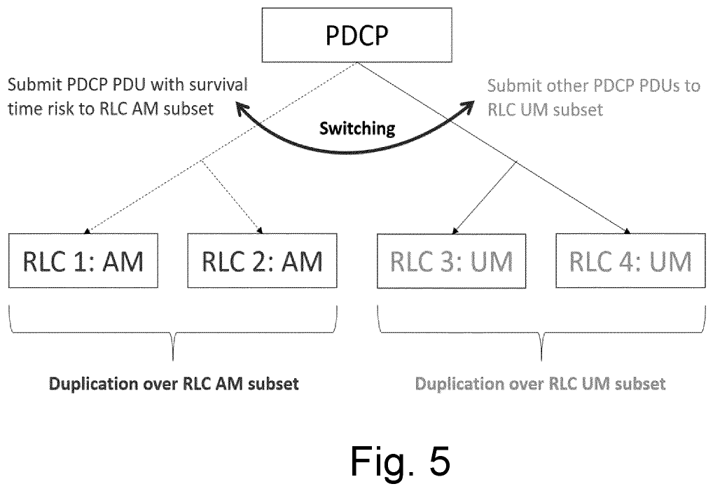

FIG. 5 shows a schematic representation of the mechanism for selecting between a subset of first RLC entities and a subset second of RLC entities to process a PDCP PDUs, where the subset of first RLC entities operate in AM while the subset of second RLC entities operate in UM.

Alternatively or additionally, when a PDCP PDU is associated with a survival time risk, the PDCP entity may also select the subset of RLC entities based on the number of RLC entities activated for duplication within the subset of first RLC entities and/or the subset of second RLC entities.

When the number of RLC entities activated in the subset of first RLC entities is greater than the number of RLC entities activated in the subset of second RLC entities, the PDCP entity may select the subset of first RLC entities to process a PDCP PDU.

When the subset of first RLC entities has two or more active first RLC entities the PDCP entity may perform duplication over the subset of first RLC entities. That is, two or more copies of the PDCP PDU are processed by the two or more active first RLC entities.

When the number of RLC entities activated in the subset of first RLC entities is lower than the number of RLC entities activated in the subset of second RLC entities, the PDCP entity may select the subset of second RLC entities to process a PDCP PDU.

When the subset of second RLC entities has two or more active first RLC entities the PDCP entity may perform duplication over the subset of second RLC entities. That is, two or more copies of the PDCP PDU are processed by the two or more active second RLC entities.

When a PDCP PDU is not associated with a survival time risk, the PDCP entity may by default select the subset of second RLC entities.

When the subset of second RLC entities has two or more active second RLC entities the PDCP entity may perform duplication over the subset of second RLC entities. That is, two or more copies of the PDCP PDU are processed by the two or more active second RLC entities.

The PDCP entity may determine whether a PDCP PDU is associated with a survival time risk based on a sequence number of the PDCP PDU or based on whether a previous PDCP PDU was successfully transmitted.

The PDCP entity may provide the PDCP PDU to the selected subset of first RLC entities or the selected subset of second RLC entities.

It will be understood that the PDCP entity does not necessarily select the subset of first RLC entities to process a PDCP PDU when the PDCP PDU is associated with a survival time risk. The PDCP entity may select the subset of first RLC entities to process a PDCP PDU when the PDCP PDU is associated with a survival time risk.

That is, other criteria, factors or conditions may be taken into consideration by the PDCP entity in addition to the PDCP PDU being associated with a survival time risk to select between the subset of first RLC entities and the subset of second RLC entities.

For example, the first RLC entities within the subset of first RLC entities may not always be active and duplication may not always be possible. AgNB may dynamically activate and/or deactivate RLC entities associated with a DRB (e.g. via a MAC control element according to Rel-16 specifications). Thus, the number of active first RLC entities within the subset of first RLC entities may be taken into consideration by the PDCP entity in addition to whether a PDCP PDU is associated with a survival time risk to select between the subset of first RLC entities and the subset of second RLC entities.

When a PDCP PDU is associated with a survival time risk, the number of active first RLC entities within the subset of first RLC entities is lower than two and the number of active second RLC entities within the subset of second RLC entities is greater than or equal to two, the PDCP entity may select the subset of second RLC entities. The PDCP entity may perform duplication over the subset of second RLC entities. In this way, potentially higher reliability and lower latency may be achieved due to duplication.

When a PDCP PDU is associated with a survival time risk and the number of active first RLC entities within the subset of first RLC entities is greater than two or equal to two, the PDCP entity may select the subset of first RLC entities. The PDCP entity may perform duplication over the subset of first RLC entities.

One or more aspects of this disclosure provide an uplink mechanism wherein a gNB may send a configuration message to a terminal to configure a PDCP entity to determine if a PDCP PDU from a PDCP entity is associated with a survival time risk.

One or more aspects of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on an operating mode of the subset of first RLC entities or the subset of second RLC entities (i.e. AM and UM).

One or more aspects of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on an operating mode of the subset of first RLC entities or an operating mode of the subset of second RLC entities (i.e. acknowledgment mode and UM) and further based on a number of active first RLC entities within the subset of first RLC entities or a number of active second RLC entities within the subset of second RLC entities.

One or more aspect of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on an operating mode of the subset of first RLC entities or an operating mode of the subset of second RLC entities (i.e. acknowledgment mode and UM) and further based on a congestion within the subset of first RLC entities or a congestion within the subset of second RLC entities.

One or more aspect of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on an operating mode of the subset of first RLC entities or an operating mode of the subset of second RLC entities (i.e. acknowledgment mode and UM) and further based on a radio link condition of a cell group serving the subset of first RLC entities or a radio link condition of a cell group serving the subset of second RLC entities. This may be applicable when a cell group serving the subset of first RLC entities is different from a cell group serving the subset of second RLC entities.

One or more aspects of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on a number of active first RLC entities within the subset of first RLC entities or a number of active second RLC entities within the subset of second RLC entities.

One or more aspect of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on a congestion within the subset of first RLC entities or a congestion within the subset of second RLC entities.

One or more aspect of this disclosure provide an uplink mechanism wherein a gNB may send a configuration message to a terminal to configure a PDCP entity to select between the subset of first RLC entities (i.e. subset of alternative RLC entities) or the subset of second RLC entities (i.e. subset of default RLC entities) to process a PDCP PDU associated with a survival time risk based on a radio link condition of a cell group serving the subset of first RLC entities or a radio link condition of a cell group serving the subset of second RLC entities. This may be applicable when a cell group serving the subset of first RLC entities is different from a cell group serving the subset of second RLC entities.

One or more aspect of this disclosure provide an uplink mechanism wherein a gNB may send a configuration message to a terminal to configure a PDCP entity to provide the PDCP PDU associated with a survival time risk to the selected subset of first RLC entities or the selected subset of second RLC entities.

It will be understood that the gNB may send one or more configuration messages to the terminal. The terminal may receive the one or more configuration messages and may configure a PDCP entity accordingly.

One or more aspects of this disclosure relate to the configuration of the terminal by the gNB.

The gNB may configure the terminal with a PDCP entity for a DRB.

The gNB may configure the terminal with one or more RLC entities of the DRB.

The gNB may configure the terminal with the operating modes of the RLC entities.

The gNB may configure the terminal with a subset of first RLC entities (i.e. subset of alternative RLC entities) operating in an AM and a subset of second RLC entities (i.e. subset of default RLC entities) operating in an UM. Alternatively, the gNB may not configure the terminal with a subset of first RLC entities (i.e. subset of alternative RLC entities) operating in an AM and a subset of second RLC entities (i.e. subset of default RLC entities) operating in an UM. The terminal may configure a subset of first RLC entities (i.e. subset of alternative RLC entities) operating in an AM and a subset of second RLC entities (i.e. subset of default RLC entities) operating in an UM based on the operating modes of the RLC entities previously configured by the gNB.

The gNB may configure the terminal with a criterion (survival time risk criterion) to allow a PDCP entity to determine that a PDCP PDU is associated with a survival time risk and that the subset of first RLC entities may be selected to process the PDCP PDU. The criterion may be based on a sequence number of the PDCP PDU. The criterion may be that the PDCP PDU is one of N PDCP PDU (e.g. N=2 or 3). N may be dependent on a survival time requirement of a data stream. The survival Time risk criterion may be that a previous PDCP PDU has not been successfully transmitted to the gNB (assuming that the PDCP entity has knowledge of whether a previous PDCP PDU has been successfully transmitted to the gNB). In this way, it may ensure that consecutive PDCP PDU are not unsuccessfully transmitted to the gNB.

The gNB may configure the terminal with the criterion (survival time risk criterion) to allow a PDCP entity to determine that a PDCP PDU is associated with a survival time risk and that the subset of first RLC entities may be selected to process the PDCP PDU in a per-DRB basis. That is, the criterion may be applied for a specific DRB as opposed to being applied for all DRBs.

The gNB may configure the terminal with a criterion (switching criterion) to allow the PDCP entity to select between the subset of first RLC entities and the subset of second RLC entities. The criterion (switching criterion) may be that the operating mode of the subset of first RLC entities is the UM and the operating mode of the subset of first RLC entities is the UM.

The gNB may configure the terminal with a further or n alternative or criterion (switching criterion) to allow the PDCP entity to select between the subset of first RLC entities and the subset of second RLC entities. The criterion (switching criterion) may be that a number of active first RLC entities within the subset of first RLC entities is greater than a number of active second RLC entities within the subset of second RLC entities. The switching criterion may be that a congestion within the subset of first RLC entities is greater than a congestion within the subset of second RLC entities. The switching criterion may be that radio link condition of a cell group serving the subset of first RLC entities is better than or a radio link condition of a cell group serving the subset of second RLC entities.

With the configuration, the PDCP entity may decide if a PDCP PDU should be submitted to the subset of first RLC entities (i.e. subset of alternative RLC entities) or to the subset of second RLC entities (subset of default RLC entities).

It will be understood that although in the above the subset of first RLC entities operating in the AM is the subset of alternative RCL entities and the subset of second RLC entities operating in the UM is the subset of default RCL entities, it could be the other way around. That is, the subset of first RLC entities operating in the AM could be the subset of default RCL entities and the subset of second RLC entities operating in the UM could be the subset of alternative RCL entities.

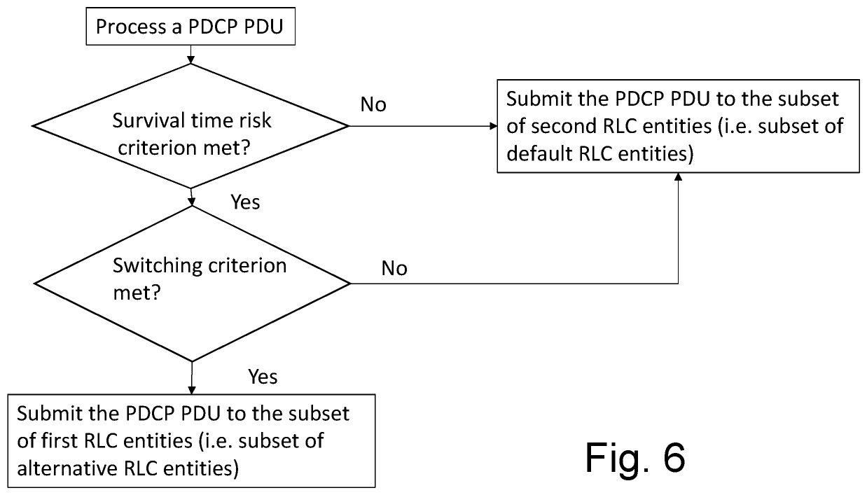

FIG. 6 shows a schematic representation of a flow chart of a method for selecting between a subset of first RLC entities and a subset of second RLC entities to process a PDCP PDU.

For each PDCP PDU a PDCP entity may determine whether the PDCP PDU is meets the survival time risk criterion. If the PDCP PDU meets the survival time risk criterion the PDCP PDU may be associated with a survival time risk. If the PDCP PDU does not meet the survival time risk criterion the PDCP PDU may not be associated with a survival time risk.

If the PDCP PDU meets the survival time risk criterion the PDCP entity, the PDCP entity may determine whether the PDCP PDU meets the switching criterion. If the PDCP PDU meets the switching criterion the PDCP entity may select the subset of first RLC entities (subset of alternative RLC entities) to process the PDCP PDU.

If the PDCP PDU does not meet the survival time risk criterion the PDCP entity may select the subset of second RLC entities (subset of default RLC entities) to process the PDCP PDU.

It must be noted that according to TS 22.104, there are several IIoT use cases that have relatively long tolerable delay (indicated by “End-to-End latency”) as well as survival time requirement (see table 5.2-1 periodic deterministic communication service performance requirements). Therefore, when the PDCP entity select the subset of first entities operating in AM to process a PDCP PDU, it may help as retransmission could be conducted despite time constraint of stringent delay budget.

One or more aspects of this disclosure provide a compromise between survival time fulfilment and computing and/or storage resource usage. More resource consuming RLC entities such as those operating in AM may only be considered when there is a risk of survival time violation. Processing complexity may be reduced as RLC entities such as those operating in AM are not used every packet PDCP PDU.

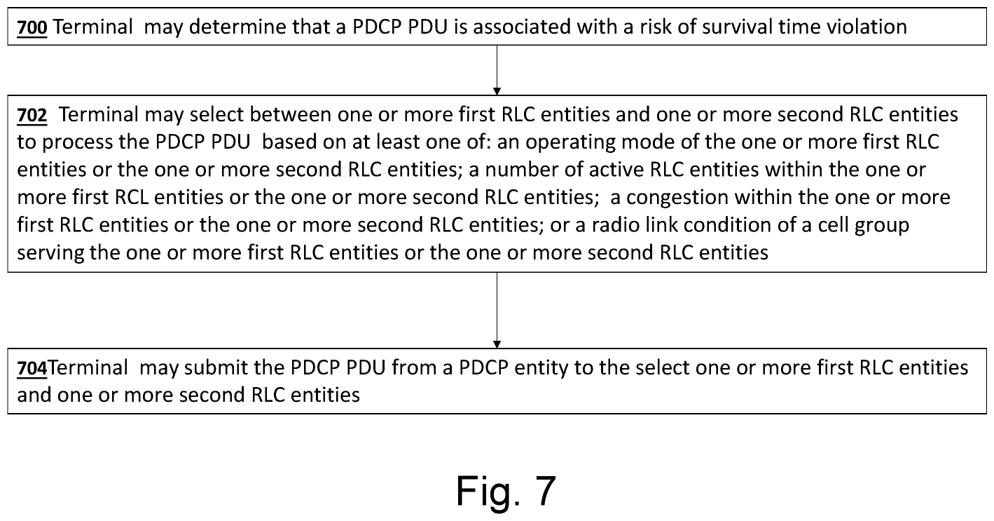

FIG. 7 shows a schematic representation of a block diagram of a method performed by a terminal for selecting between one or more first RLC entities and one or more second RLC entities to process a PDU from a PDCP entity associated with a risk of survival time violation.

In step 700 a terminal may determine that a PDU from a higher protocol layer entity is associated with a risk of survival time violation. The terminal may determine that the PDU from the higher protocol layer entity is associated with a risk of survival time violation for a specific data radio bearer. The higher protocol layer entity may be a PDCP entity.

For instance, a PDU may be associated with a risk of survival time violation if a failure to transmit the PDU may result in N consecutive PDU transmission errors and/or may result in a halt in the operation of an application.

Determining whether a PDU from the higher protocol layer entity is associated with a risk of survival time violation may be based on a sequence number of the packet data unit.

Determining whether a PDU from the higher protocol layer entity is associated with a risk of survival time violation may be based on whether a previous packet data unit was successfully transmitted.

In step 702 the terminal may select between one or more first lower data protocol entities and one or more second lower protocol layer entities to process the PDU. The one or more first lower data protocol entities may be one or more first RLC entities. The one or more second lower data protocol entities may be one or more second RLC entities.

The selection mat be based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

In some implementations, the selection may be based on: an operating mode of the one or more first lower protocol layer entities or the one or more second lower protocol layer entities; and at least one of: a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

The second lower protocol layer entities may be default lower protocol layer entities and the first lower protocol layer entities may be alternative lower protocol layer entities.

The operating mode of the one or more first lower protocol layer entities and the operating mode of the one or more second lower protocol layer entities may be one of an acknowledgement mode, an unacknowledgement mode and a transparent mode.

In an implementation, the operating mode of the one or more first lower protocol layer entities may be an AM and the operating mode of the one or more second lower protocol layer entities may be an UM.

When the number of active lower protocol layer entities of the one or more first lower protocol layer entities is greater than the number of active lower protocol layer entities of the one or more second lower protocol layer entities; the congestion within the one or more first lower protocol layer entities is lower than the one or more second lower protocol layer entities; or the radio link condition of a cell group serving the one or more first lower protocol layer entities is greater than the one or more second lower protocol layer entities, the terminal may select the one or more first lower protocol layer entities to process the PDU from the higher protocol layer entity.

When the number of active lower protocol layer entities of the one or more first lower protocol layer entities is lower than the number of active lower protocol layer entities of the one or more second lower protocol layer entities; the congestion within the one or more first lower protocol layer entities is greater than the one or more second lower protocol layer entities; or the radio link condition of a cell group serving the one or more first lower protocol layer entities is lower than the one or more second lower protocol layer entities, the terminal may select the one or more second lower protocol layer entities to process the packet data unit from the higher protocol layer entity.

In step 704 the terminal may submit the PDU from the higher protocol layer entity to the selected one or more first lower protocol layer entity or the one or more second lower protocol layer entity entities.

The terminal may determine that a PDU from the higher protocol layer entity is not associated with a risk of survival time violation. The terminal may select the one or more second lower protocol layer entities to process the PDU from the higher protocol layer entity.

The terminal may receive a configuration message from a BS: to determine that a PDU from a higher protocol layer entity is associated with a risk of survival time violation; and select between one or more first lower protocol layer entities and one or more second lower protocol layer entities to process the PDU based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

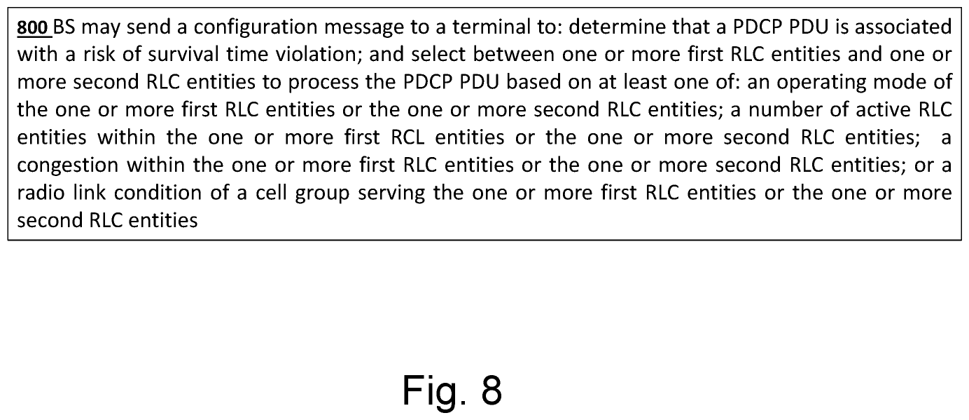

FIG. 8 shows a schematic representation of a block diagram of a method performed by a base station for selecting between one or more first RLC entities and one or more second RLC entities to process a PDU from a PDCP entity associated with a risk of survival time violation.

The BS may send a configuration message to a terminal to: to determine that a PDU from a higher protocol layer entity is associated with a risk of survival time violation; and select between one or more first lower protocol layer entities and one or more second lower protocol layer entities to process the PDU based on at least one of: an operating mode of the one or more first lower protocol layer entities or the one or more second lower protocol layer entities; a number of active lower protocol layer entities within the one or more first lower protocol layer entities or the one or more second lower protocol layer entities; a congestion within the one or more first lower protocol layer entities or the one or more second lower protocol layer entities; or a radio link condition of a cell group serving the one or more first lower protocol layer entities or the one or more second lower protocol layer entities.

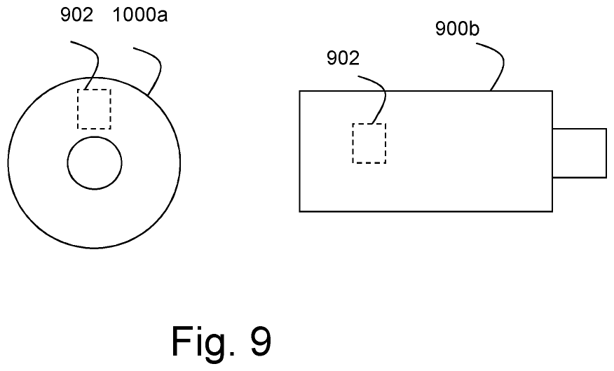

FIG. 9 shows a schematic representation of non-volatile memory media 900a (e.g. computer disc (CD) or digital versatile disc (DVD)) and 900b (e.g. universal serial bus (USB) memory stick) storing instructions and/or parameters 902 which when executed by a processor allow the processor to perform one or more of the steps of the methods of FIGS. 7 and 8.

It is noted that while the above describes example embodiments, there are several variations and modifications which may be made to the disclosed solution without departing from the scope of the present invention.

It will be understood that although the above concepts have been discussed in the context of a 5GS, one or more of these concepts may be applied to other cellular systems.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIGS. 7 and 8, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor; and
at least one memory including computer program code;
the at least one memory and the computer program code configured to, with the at least one processor, cause the apparatus at least to:
determine that a packet data unit from a higher protocol layer entity is associated with a risk of survival time violation; and
select between one or more first lower data protocol entities and one or more second lower protocol layer entities to process the packet data unit based on at least one of:
an operating mode of the one or more first lower protocol layer entities or the one or more second lower protocol layer entities;
a number of active lower protocol layer entities within the one or more first lower protocol layer entities or the one or more second lower protocol layer entities;
a congestion within the one or more first lower protocol layer entities or the one or more second lower protocol layer entities; or
a radio link condition of a cell group serving the one or more first lower protocol layer entities or the one or more second lower protocol layer entities.

2. The apparatus of claim 1, wherein the at least one memory and the computer program code are configured to, with the at least one processor, cause the apparatus at least to:
select between the one or more first lower protocol layer entities and the one or more second lower protocol layer entities to process the packet data unit from the higher protocol layer entity based on:
an operating mode of the one or more first lower protocol layer entities or the one or more second lower protocol layer entities; and at least one of:
a number of active lower protocol layer entities within the one or more first lower protocol layer entities or the one or more second lower protocol layer entities;
a congestion within the one or more first lower protocol layer entities or the one or more second lower protocol layer entities; or
a radio link condition of a cell group serving the one or more first lower protocol layer entities or the one or more second lower protocol layer entities.

3. The apparatus of claim 1, wherein the operating mode of the one or more first lower protocol layer entities and the operating mode of the one or more second lower protocol layer entities is one of an acknowledgement mode, an unacknowledgement mode and a transparent mode.

4. The apparatus claim 1, wherein the number of active lower protocol layer entities of the one or more first lower protocol layer entities is greater than the number of active lower protocol layer entities of the one or more second lower protocol layer entities;
wherein the congestion within the one or more first lower protocol layer entities is lower than the one or more second lower protocol layer entities; or
wherein the radio link condition of a cell group serving the one or more first lower protocol layer entities is greater than the one or more second lower protocol layer entities.

5. The apparatus of claim 3, wherein the at least one memory and the computer program code are configured to, with the at least one processor, cause the apparatus at least to:
select the one or more first lower protocol layer entities to process the packet data unit from the higher protocol layer entity.

6. The apparatus of claim 3, wherein the number of active lower protocol layer entities of the one or more first lower protocol layer entities is lower than the number of active lower protocol layer entities of the one or more second lower protocol layer entities;
wherein the congestion within the one or more first lower protocol layer entities is greater than the one or more second lower protocol layer entities; or
wherein the radio link condition of a cell group serving the one or more first lower protocol layer entities is lower than the one or more second lower protocol layer entities.

7. The apparatus of claim 6, wherein the at least one memory and the computer program code are configured to, with the at least one processor, cause the apparatus at least to:
select the one or more second lower protocol layer entities to process the packet data unit from the higher protocol layer entity.

8. The apparatus of claim 1, wherein the at least one memory and the computer program code are configured to, with the at least one processor, cause the apparatus at least to:
determine that a packet data unit from the higher protocol layer entity is not associated with a risk of survival time violation; and
select the one or more second lower protocol layer entities to process the packet data unit from the higher protocol layer entity.

9. The apparatus of claim 1, wherein determining whether a packet data unit from the higher protocol layer entity is associated with a risk of survival time violation is based on a sequence number of the packet data unit.

10. The apparatus of claim 1, wherein determining whether a packet data unit from the higher protocol layer entity is associated with a risk of survival time violation is based on whether a previous packet data unit was successfully transmitted.

11. The apparatus of claim 1, wherein the second lower protocol layer entities are default lower protocol layer entities and the first lower protocol layer entities are alternative lower protocol layer entities.

12. The apparatus of claim 1, wherein the at least one memory and the computer program code are configured to, with the at least one processor, cause the apparatus at least to:
submit the packet data unit from the higher protocol layer entity to the selected one or more first lower protocol layer entity or the one or more second lower protocol layer entity entities.

13. The apparatus of claim 1, wherein the at least one memory and the computer program code are configured to, with the at least one processor, cause the apparatus at least to:
determine that the packet data unit from the higher protocol layer entity is associated with a risk of survival time violation for a specific data radio bearer.

14. The apparatus of claim 1, wherein the at least one memory and the computer program code are configured to, with the at least one processor, cause the apparatus at least to:
receive a configuration message from a base station to:
determine that a packet data unit from the higher protocol layer entity is associated with a risk of survival time violation; and
select between one or more first lower protocol layer entities and one or more second lower protocol layer entities to process the packet data unit based on least one of:
an operating mode of the one or more first lower protocol layer entities or the one or more second lower protocol layer entities;
a number of active lower protocol layer entities within the one or more first lower protocol layer entities or the one or more second lower protocol layer entities;
a congestion within the one or more first lower protocol layer entities or the one or more second lower protocol layer entities; or
a radio link condition of a cell group serving the one or more first lower protocol layer entities or the one or more second lower protocol layer entities.

15. The apparatus of claim 1, wherein the higher protocol layer entity is a packet data convergence protocol entity;
wherein the one or more first lower protocol layer entities are one or more first radio link control entities; and
wherein the one or more second lower protocol layer entities are one or more second radio link control entities.

16. The apparatus of claim 1, wherein the apparatus is a terminal.

17. An apparatus comprising:
at least one processor; and
at least one memory including computer program code;
the at least one memory and the computer program code configured to, with the at least one processor, cause the apparatus at least to:
send a configuration message to a terminal to:
determine that a packet data unit from a higher protocol layer entity is associated with a risk of survival time violation; and
select between one or more first lower protocol layer entities and one or more second lower protocol layer entities to process the packet data unit based on at least one of:
an operating mode of the one or more first lower protocol layer entities or the one or more second lower protocol layer entities;
a number of active lower protocol layer entities within the one or more first lower protocol layer entities or the one or more second lower protocol layer entities;
a congestion within the one or more first lower protocol layer entities or the one or more second lower protocol layer entities; or
a radio link condition of a cell group serving the one or more first lower protocol layer entities or the one or more second lower protocol layer entities.

18. The apparatus of claim 17, wherein the apparatus is a base station.

19-21. (canceled)
